(19) United States
(12) Patent Application Publication
(10) Pub. No.: US 2014/0023387 A1
(43) Pub. Date: Jan. 23, 2014

(54) IMAGE FORMING APPARATUS

(71) Applicant: KONICA MINOLTA, INC., Tokyo (JP)

(72) Inventors: Yu GOTO, Gunma (JP); Yusuke NISHISAKA, Tokyo (JP); Shigetaka KUROSU, Tokyo (JP); Junpei SHOUNO, Kanagawa (JP); Yoshitada KARIMAI, Tokyo (JP)

(21) Appl. No.: 13/937,875

(22) Filed: Jul. 9, 2013

(30) Foreign Application Priority Data
Jul. 20, 2012 (JP) 2012-161700

(51) Int. Cl. G03G 15/16

(52) U.S. Cl. CPC G03G 15/1675
USPC 399/66; 399/121

(57) ABSTRACT

An image forming apparatus including: a transfer belt; a rotational body; a transfer roller that forms a transfer nip part between the transfer roller and the rotational body with the transfer belt therebetween; a pressing section that presses one of the rotational body and the transfer roller against the other of the rotational body and the transfer roller; and a controlling section that controls the pressing section so as to change the pressing direction of the rotational body or the transfer roller in accordance with a predetermined image formation condition.

### CROSS REFERENCE TO RELATED APPLICATIONS

This application is entitled and claims the benefit of Japanese Patent Application No. 2012-161700, filed on Jul. 20, 2012, the disclosure of which including the specification, drawings and abstract is incorporated herein by reference in its entirety.

### BACKGROUND OF THE INVENTION

1. Field of the Invention

The present invention relates to an image forming apparatus.

2. Description of Related Art

Conventionally, image forming apparatuses using the intermediate transfer belt system are known. In an image forming apparatus using the intermediate transfer belt system, a toner image formed on the outer peripheral surface of a rotating endless-transfer belt is transferred to a recording sheet that is put through a transfer nip part between an opposed roller and a secondary transfer roller.

As a technique for an image forming apparatus, a technique is proposed in which a secondary transfer roller is moved to change a pressing state of the secondary transfer roller against an intermediate transfer belt according to a contraction coefficient of a recording sheet (see Japanese Patent Application Laid-Open No. 2011-158617, for example). In addition, a technique is proposed in which the transfer nip pressure level is varied to improve the quality of an image formed on a recording sheet having a low smoothness, for example (see Japanese Patent Application Laid-Open No. 2011-107331, for example).

Incidentally, when a toner image is transferred to a thin recording sheet, the recording sheet tends to stick to a secondary transfer roller or an intermediate transfer belt since the recording sheet itself has a low stiffness. Therefore, it is required to improve a performance for separating the recording sheet (for example, a performance for separating a sheet from a transfer belt or a transfer roller) by the exit of a transfer nip part having an increased curvature. In addition, when a toner image is transferred to a thick recording sheet, it is required to achieve a stable transfer performance (transfer rate) by exerting a decreased pressure on the entire transfer nip part while ensuring a transfer nip width with at least a predetermined pressure level. Thus, there is a problem that the optimum transfer nip condition differs depending on whether the separation performance or transfer performance is required at the transfer nip part, and it is difficult to handle it by one image forming apparatus.

### SUMMARY OF THE INVENTION

It is an object of the present invention to provide an image forming apparatus capable of improving a separation performance and a transfer performance at a transfer nip part.

In order to achieve the object, an image forming apparatus reflecting one aspect of the present invention comprises: a transfer belt; a rotational body; a transfer roller that forms a transfer nip part between the transfer roller and the rotational body with the transfer belt therebetween; a pressing section that presses one of the rotational body and the transfer roller against the other of the rotational body and the transfer roller; and a controlling section that controls the pressing section so as to change a pressing direction of the rotational body or the transfer roller in accordance with a predetermined image formation condition.

Preferably, in the above-mentioned image forming apparatus, the transfer belt is an intermediate transfer belt, the rotational body is a photoconductor drum, and the transfer roller is a primary transfer roller.

Preferably, in the above-mentioned image forming apparatus, the transfer belt is an intermediate transfer belt, the rotational body is an opposed roller, and the transfer roller is a secondary transfer roller.

Preferably, in the above-mentioned image forming apparatus, the image formation condition includes a basis weight of a recording sheet put through the transfer nip part.

Preferably, in the above-mentioned image forming apparatus, the image formation condition includes at least one of a temperature and a relative humidity around the image forming apparatus.

Preferably, in the above-mentioned image forming apparatus, the image formation condition includes a type of the recording sheet.

Preferably, in the above-mentioned image forming apparatus, the image formation condition includes a level relation between a hardness of the rotational body and a hardness of the transfer roller.

Preferably, in the above-mentioned image forming apparatus, the pressing section includes a first spring that biases the rotational body or the transfer roller in a first direction, and a second spring that biases the rotational body or the transfer roller in a second direction, and the controlling section selectively activates a biasing force of the first spring or a biasing force of the second spring to change the pressing direction of the rotational body or the transfer roller.

Preferably, in the above-mentioned image forming apparatus, the pressing section includes a spring that biases the rotational body or the transfer roller in a predetermined direction, and a turnable arm member having a first end connected to the rotational body or the transfer roller and a second end serving as a fulcrum, and the controlling section changes a position of the fulcrum to change the pressing direction of the rotational body or the transfer roller.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a control block diagram of an image forming apparatus according to the present embodiment;

FIG. 2 illustrates a configuration for forming a transfer nip part according to the present embodiment;

FIG. 3 illustrates a form of an exit of a transfer nip part;

FIG. 4 illustrates a pressure distribution at the transfer nip part;

FIG. 5 illustrates a modification of a configuration for forming a transfer nip part according to the present embodiment; and

FIG. 6 illustrates another modification of a configuration for forming a transfer nip part according to the present embodiment.

### DESCRIPTION OF THE PREFERRED EMBODIMENTS

In the following, the present embodiment is described in detail with reference to the drawings.

[Configuration of Image Forming Apparatus 100]

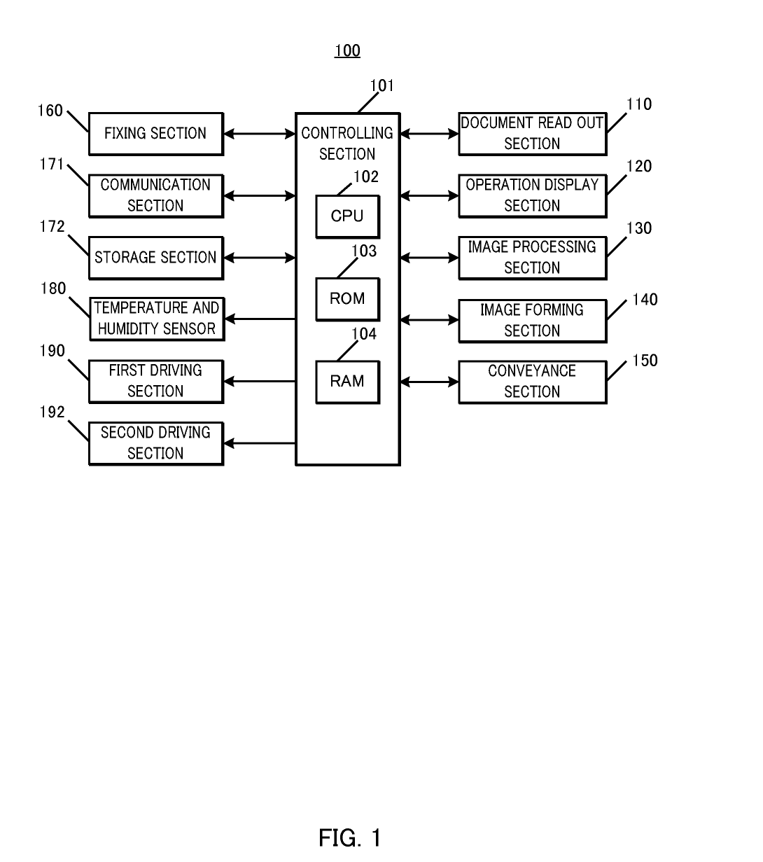

Image forming apparatus 100 illustrated in FIG. 1 forms an image on a recording sheet by the electrophotographic process. Image forming apparatus 100 includes controlling section 101, document read out section 110, operation display section 120, image processing section 130, image forming section 140, conveyance section 150, fixing section 160, communication section 171, storage section 172, temperature and humidity sensor 180, first driving section 190, and second driving section 192.

Controlling section 101 includes central processing unit (CPU) 102, read only memory (ROM) 103, random access memory (RAM) 104, and the like. CPU 102 reads out a program corresponding to processing details from ROM 103, loads the program in RAM 104, and performs a centralized control of operations of the blocks of image forming apparatus 100 in conjunction with the loaded program. At this time, various kinds of data stored in storage section 172 are referenced. Storage section 172 is composed of a nonvolatile-semiconductor memory (so-called flash memory) or a hard disk drive, for example.

Controlling section 101 exchanges various kinds of data, via communication section 171, with an external apparatus (for example, a personal computer) connected through a communication network such as local area network (LAN) and wide area network (WAN). For example, controlling section 101 receives image data (input image data) sent from the external apparatus, and forms an image on a recording sheet based on the received image data. Communication section 171 is composed of a communication control card such as a LAN card, for example.

Document read out section 110 optically scans a document conveyed onto a contact glass and brings light reflected from a document into an image on a light reception surface of charge coupled device (CCD) sensor, thereby reading out the image of the document. It is to be noted that, while the document is conveyed onto the contact glass by an automatic document paper feeder (ADF), the document may be manually placed on the contact glass.

Operation display section 120 includes a touch screen. Users can perform inputting operation for various kinds of instructions and settings from the touch screen. In addition, users can set, for example, the type (sheet type) and basis weight of a recording sheet from operation display section 120. The type (sheet type) and basis weight of a recording sheet set from operation display section 120 is recorded in storage section 172 as recording sheet information.

Image processing section 130 includes a circuit for performing analog-to-digital (A/D) conversion processing and a circuit for performing digital image processing. Image processing section 130 performs A/D conversion processing on an analog image signal acquired by a CCD sensor of document read out section 110 to generate digital image data, and outputs the generated digital image data to image forming section 140.

Image forming section 140 emits laser light based on the digital image data generated by image processing section 130, and irradiates the emitted laser light on a photoconductor drum to form an electrostatic latent image on the photoconductor drum (light exposure step).

Image forming section 140 includes configurations for carrying out steps including, in addition to the above-mentioned light exposure step, a charging step that is performed prior to the light exposure step, a development step that is performed after the light exposure step, a transferring step subsequent to the development step, and a cleaning step subsequent to the transferring step.

In the charging step, image forming section 140 uses corona discharging from a charging device to uniformly charge the surface of the photoconductor drum. In the development step, image forming section 140 causes toner contained in a developer in a developing device to adhere to an electrostatic latent image on the photoconductor drum, and thus forms a toner image on the photoconductor drum.

In the transferring step, image forming section 140 primary-transfers the toner image formed on the photoconductor drum to an intermediate transfer belt. In addition, image forming section 140 secondary-transfers the toner image formed on the intermediate transfer belt to a recording sheet conveyed by conveyance section 150 at a secondary transfer nip part. In the cleaning step, image forming section 140 removes toner remaining on the photoconductor drum after the transferring step.

Fixing section 160 includes a heating roller, a fixing roller, a fixing belt, and a pressure roller. The heating roller and fixing roller are disposed with a predetermined distance therebetween. A fixing belt is provided around the heating roller and fixing roller. The pressure roller is disposed in a state where it is in pressure contact with the fixing belt in a region where the fixing belt and fixing roller are in contact with each other. A fixing nip part is formed at a part where the fixing belt and pressure roller make contact with each other.

Fixing section 160 applies heat and pressure to the toner image formed on the recording sheet introduced in the fixing nip part (thermal fixation), thereby fixing the toner image to the recording sheet (fixing step). Thus, a fixed toner image is formed on the recording sheet. The recording sheet subjected to the thermal fixation by fixing section 160 is ejected from image forming apparatus 100.

Temperature and humidity sensor 180 is installed in image forming apparatus 100 to detect the temperature and relative humidity in image forming apparatus 100 and outputs results of the detection to controlling section 101.

Upon reception of a control command from controlling section 101, first driving section 190 rotates slide cum 260 described later. First driving section 190 is composed of a combination of a motor, a gear, and the like, for example.

Upon reception of a control command from controlling section 101, second driving section 192 rotates slide cum 270 described later. Second driving section 192 is composed of a combination of a motor, a gear, and the like, for example.

[Configuration of Secondary Transfer Nip Part NP]

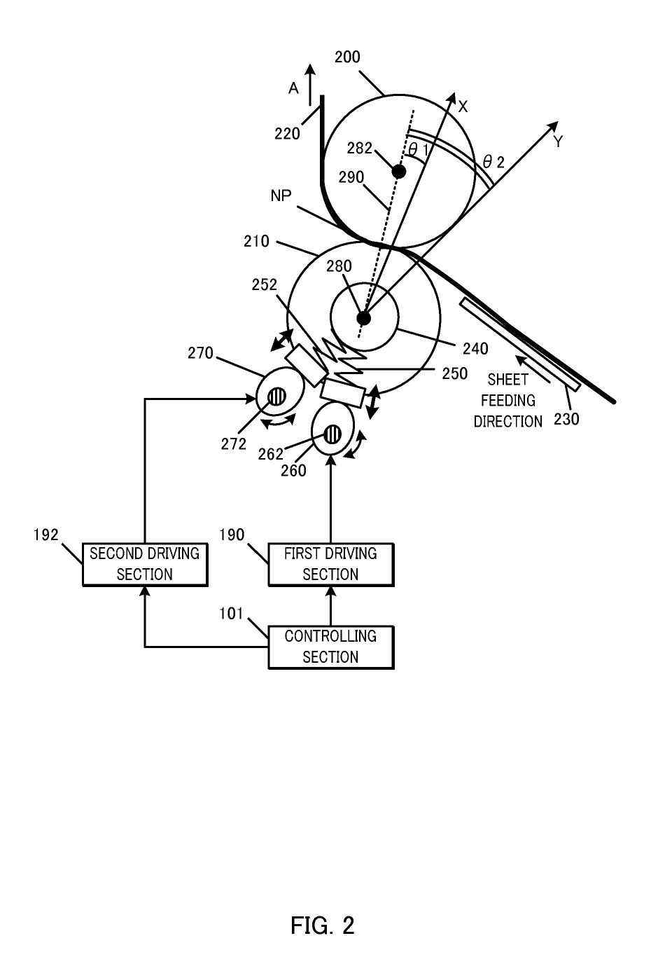

Next, a configuration for forming a secondary transfer nip part NP is described. As illustrated in FIG. 2, intermediate transfer belt 220 is sandwiched between opposed roller 200 (rotational body) and secondary transfer roller 210 (transfer roller). With such a configuration, secondary transfer nip part NP is formed in which opposed roller 200 and secondary transfer roller 210 make contact with each other with intermediate transfer belt 220 therebetween. By applying a transfer voltage having a reverse polarity relative to toner to opposed roller 200 or secondary transfer roller 210, a toner image formed on intermediate transfer belt 220 is secondary-transferred to recording sheet 230 at secondary transfer nip part NP.

Intermediate transfer belt 220 is provided in a loop form around a plurality of support rollers (not illustrated) and opposed roller 200. With the rotation of the support rollers, intermediate transfer belt 220 moves in an arrow A direction at a constant speed.

Intermediate transfer belt 220 is an endless belt, and is composed of a semiconductor belt made of polyimide (PI), for example. When intermediate transfer belt 220 is brought into pressure contact with recording sheet 230 by secondary transfer roller 210, the toner image primary-transferred on intermediate transfer belt 220 is secondary-transferred to recording sheet 230.

Secondary transfer roller 210 has a three layer structure including a mandrel, an intermediate layer, and a surface layer. Secondary transfer roller 210 has an outer diameter of 24 [mm], and a hardness (Asker-C) of 35[°].

Opposed roller 200 is disposed at a position where opposed roller 20 faces secondary transfer roller 210 with intermediate transfer belt 220 therebetween. Opposed roller 200 is composed of a solid roller. Opposed roller 200 has an outer diameter of 24 [mm], and a hardness (Asker-C) of 69[°]. Opposed roller 200 has a hardness greater than that of secondary transfer roller 210.

Rotational axis end portion 240 of secondary transfer roller 210 is connected to first driving section 190 via pressing spring 250 (first spring) and slide cum 260. Upon reception of a drive command from controlling section 101, first driving section 190 rotates slide cum 260 around axis 262. When first driving section 190 rotates slide cum 260, pressing spring 250 biases secondary transfer roller 210 in an arrow X direction (first direction). When biased with pressing spring 250, secondary transfer roller 210 presses opposed roller 200 in the arrow X direction. Angle θ1 (for example, 10 [deg]) formed by dotted line 290 passing through the center point of rotational axis 280 of secondary transfer roller 210 and the center point of rotational axis 282 of opposed roller 200, and the arrow X direction is smaller than a predetermined angle (for example, 15 [deg], the same shall apply hereinafter). In the following, the arrow X direction is referred to as axis center side direction X.

Rotational axis end portion 240 of secondary transfer roller 210 is connected to second driving section 192 via pressing spring 252 (second spring) and slide cum 270. Upon reception of a drive command from controlling section 101, second driving section 192 rotates slide cum 270 around axis 272. When second driving section 192 rotates slide cum 270, pressing spring 252 biases secondary transfer roller 210 in an arrow Y direction (second direction). When biased by pressing spring 252, secondary transfer roller 210 presses opposed roller 200 in the arrow Y direction. Angle θ2 (for example, 30 [deg]) formed by dotted line 290 passing through the center point of rotational axis 280 of secondary transfer roller 210 and the center point of rotational axis 282 of opposed roller 200, and the arrow Y direction is greater than a predetermined angle. In the following, the arrow Y direction is referred to as upstream side direction Y.

It is to be noted that first driving section 190, second driving section 192, slide cums 260 and 270, and pressing springs 250 and 252 function as a pressing section of the present invention.

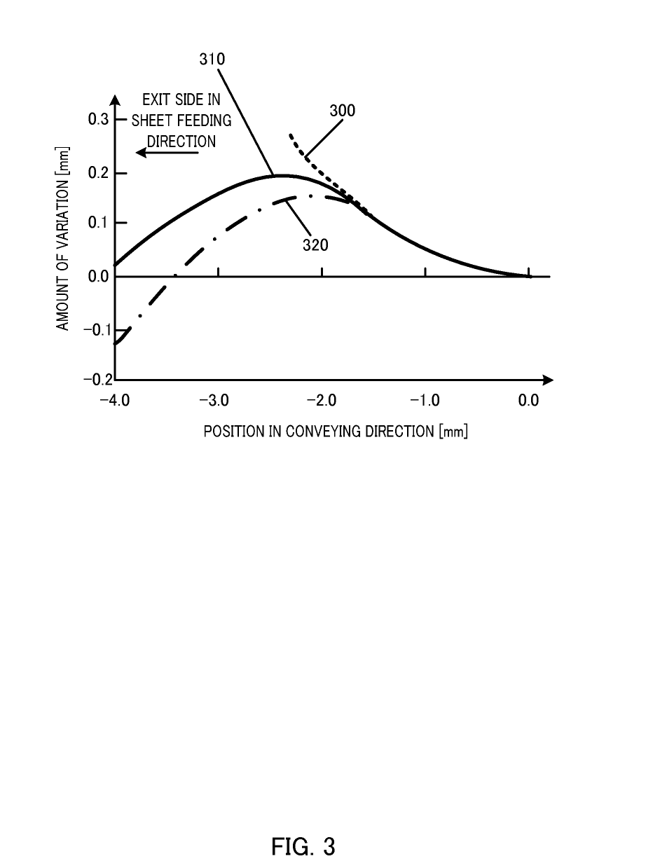

FIG. 3 illustrates a state where the form (nip form) of the exit of secondary transfer nip part NP varies according to the pressing direction of secondary transfer roller 210. Dotted line 300 represents a form of the outer peripheral surface of opposed roller 200 in the vicinity of the exit of secondary transfer nip part NP. Solid line 310 represents a form of the outer peripheral surface of secondary transfer roller 210 in the vicinity of the exit of secondary transfer nip part NP when the pressing direction of secondary transfer roller 210 is the axis center side direction X. Dashed line 320 represents a form of the outer peripheral surface of secondary transfer roller 210 in the vicinity of the exit of secondary transfer nip part NP when the pressing direction of secondary transfer roller 210 is the upstream side direction Y.

The curvature of outer peripheral surface 320 of secondary transfer roller 210 in the case where the pressing direction of secondary transfer roller 210 is the upstream side direction Y is greater than the curvature of outer peripheral surface 310 of secondary transfer roller 210 in the case where the pressing direction is the axis center side direction X. Therefore, when the pressing direction of secondary transfer roller 210 is the upstream side direction Y, the performance for separating recording sheet 230 at secondary transfer nip part NP can be improved in comparison with the case where the pressing direction is the axis center side direction X.

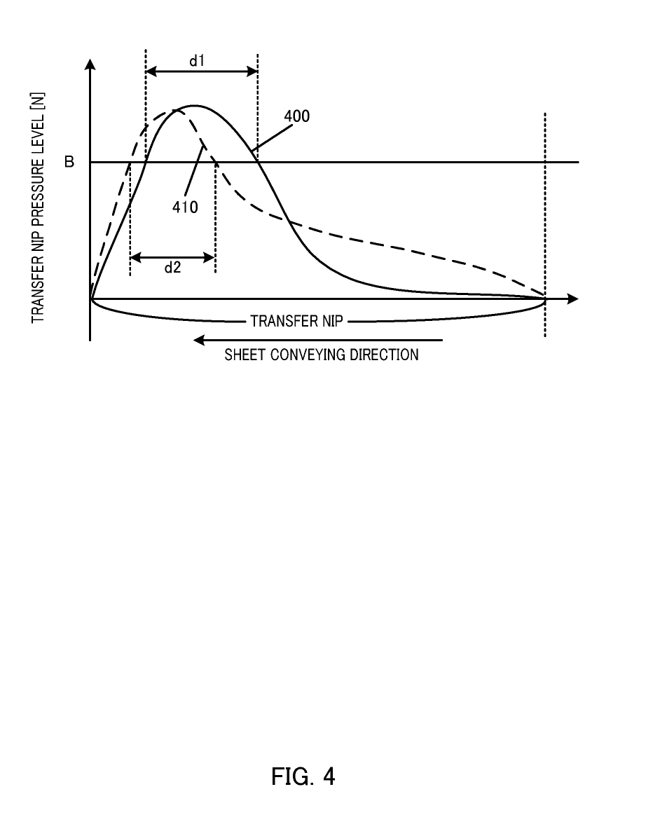

FIG. 4 illustrates a state where the pressure distribution at secondary transfer nip part NP varies along the conveying direction of recording sheet 230 according to the pressing direction of secondary transfer roller 210. Solid line 400 represents a pressure distribution at secondary transfer nip part NP when the pressing direction of secondary transfer roller 210 is the axis center side direction X. Dotted line 410 represents a pressure distribution at secondary transfer nip part NP when the pressing direction at secondary transfer roller 210 is the upstream side direction Y.

When a stable transfer performance is required as in the case where recording sheet 230 is a thick sheet for example, it is necessary that the length of a transfer nip width in which the transfer nip pressure level is equal to or greater than a predetermined pressure level B (for example, 45[N]) be equal to or greater than a predetermined value. The symbol d1 represents a transfer nip width in which the transfer nip pressure level is equal to or greater than the predetermined pressure level B in the case where the pressing direction of secondary transfer roller 210 is the axis center side direction X. The symbol d2 represents a transfer nip width in which the transfer nip pressure level is equal to or greater than the predetermined pressure level B in the case where the pressing direction of secondary transfer roller 210 is the upstream side direction Y. As illustrated in FIG. 4, the transfer nip width d1 is greater than the transfer nip width d2. In addition, the total pressure (total value of the transfer nip pressure represented by solid line 400) that acts on secondary transfer nip part NP in the case where the pressing direction of secondary transfer roller 210 is the axis center side direction X is smaller than the total pressure that acts on secondary transfer nip part NP (total value of the transfer nip pressure represented by dotted line 410) in the case where the pressing direction is the upstream side direction Y. Therefore, when the pressing direction of secondary transfer roller 210 is the axis center side direction X, the performance for transferring recording sheet 230 at secondary transfer nip part NP can be improved in comparison with the case where the pressing direction is the upstream side direction Y.

In the case of an image formation condition that requires the performance for separating recording sheet 230 at secondary transfer nip part NP, controlling section 101 controls second driving section 192 so that the pressing direction of secondary transfer roller 210 is the upstream side direction Y. In the case of an image formation condition that requires the performance for transferring recording sheet 230 at secondary transfer nip part NP, controlling section 101 controls first driving section 190 so that the pressing direction of secondary transfer roller 210 is the axis center side direction X.

Of the basis weight of recording sheet 230, the type of recording sheet 230, the temperature and humidity environment in image forming apparatus 100, and the level relation between the hardness of opposed roller 200 and that of secondary transfer roller 210, the image formation condition includes at least the basis weight of recording sheet 230. In the present embodiment, as for the level relation between the hardness of opposed roller 200 and that of secondary transfer roller 210, the hardness of secondary transfer roller 210 is smaller than that of opposed roller 200. In addition to the basis weight of recording sheet 230, users can set any parameters to be included in the image formation condition from operation display section 120.

Controlling section 101 refers to recording sheet information stored in storage section 172 to identify the basis weight and type of recording sheet 230. When the basis weight of recording sheet 230 is smaller than a predetermined basis weight (for example, 105 [g/m²], the same shall apply hereinafter), controlling section 101 determines that recording sheet 230 is a thin sheet. Meanwhile, when the basis weight of recording sheet 230 is equal to or greater than a predetermined basis weight, controlling section 101 determines that recording sheet 230 is a thick sheet.

Controlling section 101 identifies the temperature and humidity environment (for example, high temperature and high humidity environment, normal temperature and normal humidity environment, low temperature and low humidity environment, and the like) in image forming apparatus 100 on the basis of the temperature and relative humidity output from temperature and humidity sensor 180. For example, when the result of the detection by temperature and humidity sensor 180 is equal to or greater than a first predetermined temperature (for example, 25[° C.]), and at the same time, equal to or greater than a first predetermined relative humidity (for example, 60[%]), controlling section 101 determines that the temperature and humidity environment in image forming apparatus 100 is a high temperature and high humidity environment. Meanwhile, when the result of the detection by temperature and humidity sensor 180 is smaller than a second predetermined temperature (for example 15[° C.]), and at the same time, smaller than a second predetermined relative humidity (for example, 35[%]), controlling section 101 determines that the environment in image forming apparatus 100 is a low temperature and low humidity environment.

For example, when the image formation condition includes the basis weight of recording sheet 230, the type of recording sheet 230, and the temperature and humidity environment in image forming apparatus 100, controlling section 101 performs the following control operation. When the basis weight of recording sheet 230 is smaller than a predetermined basis weight, the type of recording sheet 230 is a coated sheet, and the temperature and humidity environment in image forming apparatus 100 is a high temperature and high humidity environment, controlling section 101 determines that the performance for separating recording sheet 230 at secondary transfer nip part NP is required, and controls second driving section 192 so that the direction in which secondary transfer roller 210 presses opposed roller 200 is the upstream side direction Y. It is to be noted that, when the type of recording sheet 230 is a coated sheet, recording sheet 230 itself has a low stiffness and thus tends to stick to secondary transfer roller 210 or intermediate transfer belt 220, whereby the performance for separating recording sheet 230 at secondary transfer nip part NP is degraded. In addition, when the temperature and humidity environment in image forming apparatus 100 is a high temperature and high humidity environment, the moisture content of recording sheet 230 increases and thus recording sheet 230 tends to stick to secondary transfer roller 210 or intermediate transfer belt 220, whereby the performance for separating recording sheet 230 at secondary transfer nip part NP is degraded.

In addition, when the image formation condition includes the basis weight of recording sheet 230, and the temperature and humidity environment in image forming apparatus 100, controlling section 101 performs the following control operation. When the basis weight of recording sheet 230 is equal to or greater than a predetermined basis weight, and, the temperature and humidity environment in image forming apparatus 100 is a high temperature and high humidity environment or a normal temperature and normal humidity environment, controlling section 101 determines that the performance for separating recording sheet 230 at secondary transfer nip part NP is required, and controls second driving section 192 so that the direction in which secondary transfer roller 210 presses opposed roller 200 is the upstream side direction Y. Otherwise, controlling section 101 determines that the performance for transferring recording sheet 230 at secondary transfer nip part NP is required, and controls first driving section 190 so that the direction in which secondary transfer roller 210 presses opposed roller 200 is the axis center side direction X.

### Effect of the Present Embodiment

As has been described in detail, the present embodiment includes intermediate transfer belt 220, opposed roller 200, secondary transfer roller 210 that forms secondary transfer nip part NP between secondary transfer roller 210 and opposed roller 200 with intermediate transfer belt 220 therebetween, the pressing section (first driving section 190, second driving section 192, slide cums 260 and 270, and pressing springs 250 and 252) that presses secondary transfer roller 210 against opposed roller 200, and controlling section 101 that controls the pressing section so as to change the pressing direction of secondary transfer roller 210 according to a predetermined image formation condition.

With the above-mentioned configuration of the present embodiment, the pressing direction of secondary transfer roller 210 is changed according to whether the image formation condition is a condition that requires improvement in separation performance or a condition that requires improvement in transfer performance, and thus secondary transfer nip part NP having a form suitable for the image formation condition is formed. Therefore, the separation performance and transfer performance at secondary transfer nip part NP can be improved.

[Modification]

It is to be noted that, while an example is described in the above-mentioned embodiment in which recording sheet information stored in storage section 172 is referenced to identify the basis weight of recording sheet 230, the present invention is not limited to this. For example, the basis weight of recording sheet 230 may be identified based on results of detection by a sheet thickness detection sensor provided on a conveyance path of recording sheet 230. The sheet thickness detection sensor is a photo sensor of a reflection type that detects the thickness of recording sheet 230 and outputs a sheet thickness detection signal to controlling section 101. Specifically, the sheet thickness detection sensor detects the thickness of recording sheet 230 by detecting the distance between axes of a pair of rollers, which varies according to the thickness of recording sheet 230 conveyed as being sandwiched between the rollers. Controlling section 101 references the sheet thickness detection signal output from sheet thickness detection sensor, and determines that the basis weight of recording sheet 230 is equal to or greater than a predetermined basis weight when the thickness of recording sheet 230 is equal to or greater than a predetermined value, or that the basis weight of recording sheet 230 is smaller than a predetermined basis weight when the thickness of recording sheet 230 is smaller than a predetermined value.

In addition, while an example is described in the above-mentioned embodiment in which the image formation condition includes the temperature and humidity environment (temperature and relative humidity) in image forming apparatus 100, the present invention is not limited to this. For example, the image formation condition may include only any of the temperature, relative humidity, absolute humidity computed based on the temperature and relative humidity in image forming apparatus 100.

In addition, while an example is described in the above-mentioned embodiment in which temperature and humidity sensor 180 is installed in image forming apparatus 100, the present invention is not limited to this. For example, temperature and humidity sensor 180 may be installed outside of image forming apparatus 100.

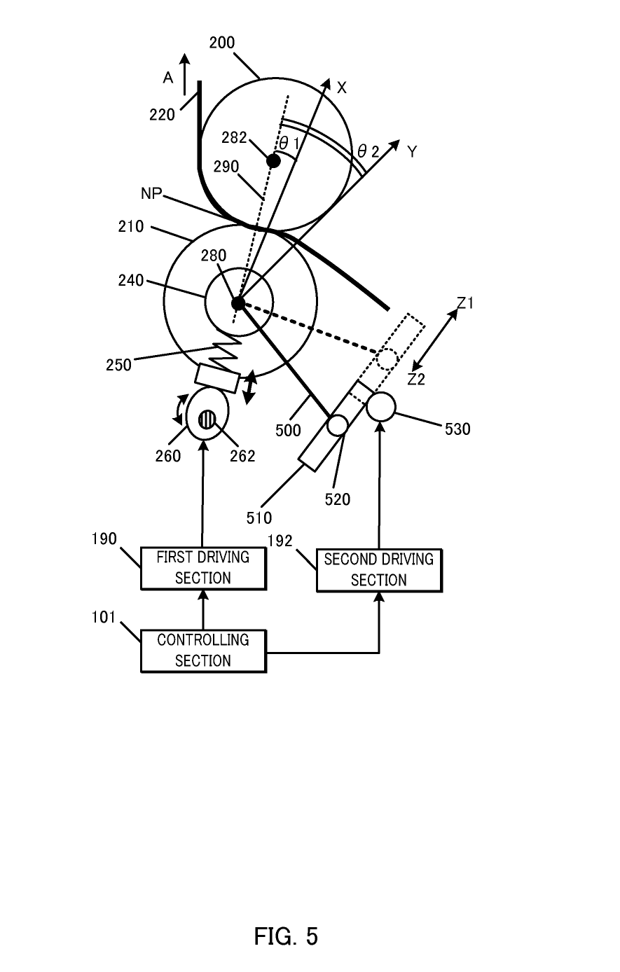

In addition, while an example is described in the above-mentioned embodiment in which the pressing direction of secondary transfer roller 210 against opposed roller 200 is changed by selectively activating the biasing force of pressing spring 250 or the biasing force of pressing spring 252, the present invention is not limited to this. For example, the pressing direction of secondary transfer roller 210 against opposed roller 200 may be changed by providing pressing spring 250 that biases opposed roller 200 in the axis center side direction X, and turnable arm member 500 that has a first end connected to secondary transfer roller 210 and a second end serving as fulcrum 520 as illustrated in FIG. 5, and by changing the position of fulcrum 520.

In FIG. 5, as a mechanism for changing the position of fulcrum 520, a rack and pinion mechanism including circular gear (pinion) 530 and rack 510 composed of a toothed plate bar is employed. Rack 510 is provided with fulcrum 520 of arm member 500. Upon reception of a drive command from controlling section 101, second driving section 192 rotates pinion 530 in the clockwise direction or counterclockwise direction. When rotating pinion 530 in the clockwise direction, rack 510 moves in an arrow Z1 direction. In this case, second driving section 192 rotates pinion 530 in the clockwise direction until the angle formed by arm member 500 and axis center side direction X becomes 90[deg]. Thereafter, under a drive command from controlling section 101, first driving section 190 rotates slide cum 260 around axis 262. When first driving section 190 rotates slide cum 260, pressing spring 250 biases secondary transfer roller 210 in the axis center side direction X. When biased by pressing spring 250, secondary transfer roller 210 presses opposed roller 200 in the axis center side direction X.

Meanwhile, when pinion 530 is rotated in the counterclockwise direction, rack 510 moves in an arrow Z2 direction. In this case, second driving section 192 rotates pinion 530 until the angle formed by arm member 500 and upstream side direction Y becomes 90[deg]. Thereafter, under a drive command from controlling section 101, first driving section 190 rotates slide cum 260 around axis 262. When first driving section 190 rotates slide cum 260, pressing spring 250 biases secondary transfer roller 210 in the upstream direction Y. When biased by pressing spring 250, secondary transfer roller 210 presses opposed roller 200 in the upstream side direction Y. Thus, by changing the position of fulcrum 520 of arm member 500, the pressing direction of secondary transfer roller 210 against opposed roller 200 can be changed.

In addition, while an example is described in the above-mentioned embodiment in which secondary transfer roller 210 has a hardness lower than that of opposed roller 200, secondary transfer roller 210 may have a hardness greater than that of opposed roller 200.

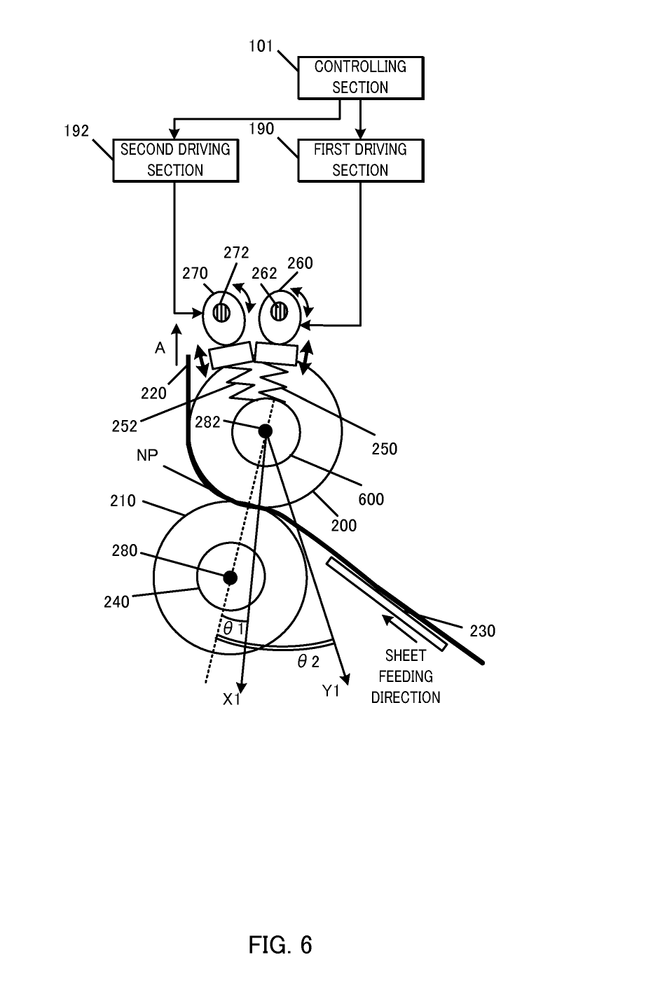

In addition, while an example is described in the above-mentioned embodiment in which secondary transfer roller 210 is pressed against opposed roller 200, the present invention is not limited to this. FIG. 6 illustrates an example in which opposed roller 200 is pressed against secondary transfer roller 210, for example.

In the example of FIG. 6, rotational axis end portion 600 of opposed roller 200 is connected to first driving section 190 via pressing spring 250 and slide cum 260. When first driving section 190 rotates slide cum 260, pressing spring 250 biases opposed roller 200 in an arrow X1 direction. When biased by pressing spring 250, opposed roller 200 presses secondary transfer roller 210 in the arrow X1 direction. In the case of an image formation condition that requires the performance for transferring recording sheet 230 at secondary transfer nip part NP, controlling section 101 controls first driving section 190 in such a manner that the pressing direction of secondary transfer roller 210 is arrow X1 direction.

Rotational axis end portion 600 of opposed roller 200 is connected to second driving section 192 via pressing spring 252 and slide cum 270. When second driving section 192 rotates slide cum 270, pressing spring 252 biases opposed roller 200 in an arrow Y1 direction. When biased by pressing spring 252, opposed roller 200 presses secondary transfer roller 210 in the arrow Y1 direction. In the case of an image formation condition that requires the performance for separating recording sheet 230 at secondary transfer nip part NP, controlling section 101 controls second driving section 192 in such a manner that the pressing direction of secondary transfer roller 210 is the arrow Y1 direction.

It should be understood by those skilled in the art that various modifications, combinations, sub-combinations and alterations may occur depending on design requirements and other factors in so far as they are within the scope of the appended claims or the equivalents thereof.

What is claimed is:

1. An image forming apparatus comprising:
a transfer belt;
a rotational body;
a transfer roller that forms a transfer nip part between the transfer roller and the rotational body with the transfer belt therebetween;
a pressing section that presses one of the rotational body and the transfer roller against the other of the rotational body and the transfer roller; and
a controlling section that controls the pressing section so as to change a pressing direction of the rotational body or the transfer roller in accordance with a predetermined image formation condition.

2. The image forming apparatus according to claim 1, wherein
the transfer belt is an intermediate transfer belt,
the rotational body is a photoconductor drum, and
the transfer roller is a primary transfer roller.

3. The image forming apparatus according to claim 1, wherein
the transfer belt is an intermediate transfer belt,
the rotational body is an opposed roller, and
the transfer roller is a secondary transfer roller.

4. The image forming apparatus according to claim 1, wherein
the image formation condition includes a basis weight of a recording sheet put through the transfer nip part.

5. The image forming apparatus according to claim 4, wherein
the image formation condition includes at least one of a temperature and a relative humidity around the image forming apparatus.

6. The image forming apparatus according to claim 4, wherein
the image formation condition includes a type of the recording sheet.

7. The image forming apparatus according to claim 4, wherein
the image formation condition includes a level relation between a hardness of the rotational body and a hardness of the transfer roller.

8. The image forming apparatus according to claim 1, wherein
the pressing section includes a first spring that biases the rotational body or the transfer roller in a first direction, and a second spring that biases the rotational body or the transfer roller in a second direction, and
the controlling section selectively activates a biasing force of the first spring, or, a biasing force of the second spring to change the pressing direction of the rotational body or the transfer roller.

9. The image forming apparatus according to claim 1, wherein
the pressing section includes a spring that biases the rotational body or the transfer roller in a predetermined direction, and a turnable arm member having a first end connected to the rotational body or the transfer roller and a second end serving as a fulcrum, and
the controlling section changes a position of the fulcrum to change the pressing direction of the rotational body or the transfer roller.
